(19) United States
(12) Patent Application Publication
(10) Pub. No.: US 2012/0023096 A1
(43) Pub. Date: Jan. 26, 2012

(54) SYSTEM TO DETERMINE VALUE OF REFERRAL

(75) Inventors: Scott W. Slinker, San Jose, CA (US); Anthony A. Shah-Nazaroff, Santa Clara, CA (US); James T. Brady, San Jose, CA (US)

(73) Assignee: Jake Knows, Inc., San Jose, CA (US)

(21) Appl. No.: 13/094,584

(22) Filed: Apr. 26, 2011

Related U.S. Application Data
(60) Provisional application No. 61/328,595, filed on Apr. 27, 2010.

(51) Int. Cl. G06F 17/30

(52) U.S. Cl. 707/723; 707/E17.014

(57) ABSTRACT

A system comprising a database containing information concerning uniquely identified entities is described. The database further contains a list of attributes describing the entities and describing products, skills, or services provided by that entity. A server compares the desired referral of a first entity to one or more second entities having the desired product, skill, or service, and by evaluating the relationship between the first entity and second entities presents those second entities in the order of their value as a referral.

### RELATED APPLICATION

The present application claims the benefit under 35 U.S.C. 119(e) of U.S. Provisional Patent Application Ser. No. 61/328,595, filed on Apr. 27, 2010, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010, Jake Knows, Inc, All Rights Reserved.

### TECHNICAL FIELD

Example embodiments relate to discovering, and determining the value of, referrals from an entity or entities having relationships with one or more people, based on a database that links the entity requesting the referral, such that the requesting entity will be given a list of one or more referrals with a ranked score indicating the relative value of each referral.

### BACKGROUND

In one's business and personal life, a referral to a reliable source for a product, service or skill is frequently needed but often proves difficult to find, resulting in many referrals having undesired outcomes.

### BRIEF DESCRIPTION OF THE DRAWINGS

FIG. 1 is a representation of the environment, according to an example embodiment.

FIG. 2 is a drawing of the cell phone client architecture, according to an example embodiment.

FIG. 3 is a drawing of an Internet appliance architecture, according to an example embodiment.

FIG. 4 is a drawing of the server architecture, according to an example embodiment.

FIG. 5 is a representation of the entity table entry, according to an example embodiment.

FIG. 6 is a representation of a contact list entry, according to an example embodiment.

FIG. 7 is a representation of a referral request query, according to an example embodiment

FIG. 8 is a representation of the communications log, according to an example embodiment

FIG. 9 is a representation of an attribute descriptor, according to an example embodiment.

FIG. 10 is a diagram of a representative attribute graph, according to an example embodiment.

FIG. 11 is a flow diagram of the referral selection process, according to an example embodiment.

FIG. 12 is a block diagram of machine in the example form of a computer system within which a set instructions for causing the machine to perform any one or more of the methodologies discussed herein may be executed.

### DETAILED DESCRIPTION

In the following description, for purposes of explanation, numerous specific details are set forth in order to provide a thorough understanding of some example embodiments. It will be evident, however, to one skilled in the art that the present embodiments of the invention may be practiced without these specific details.

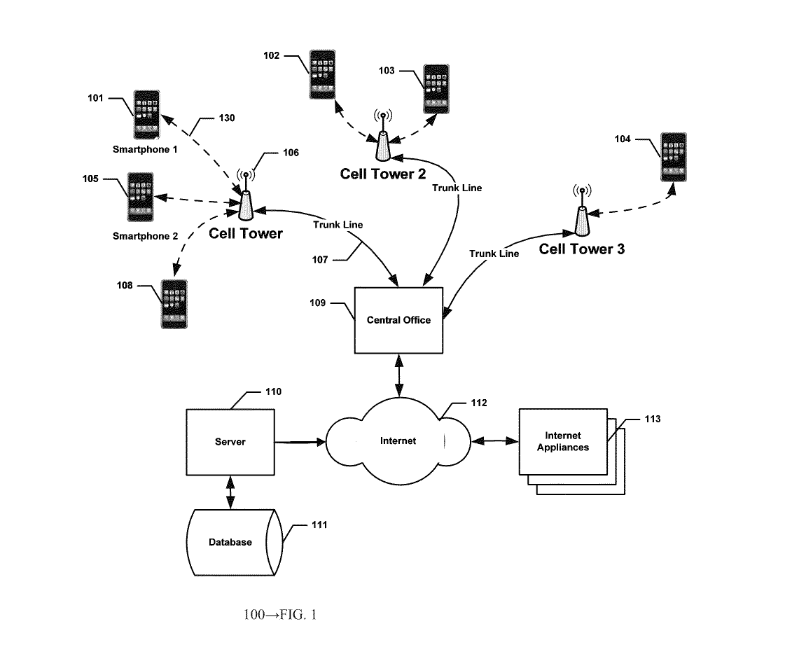

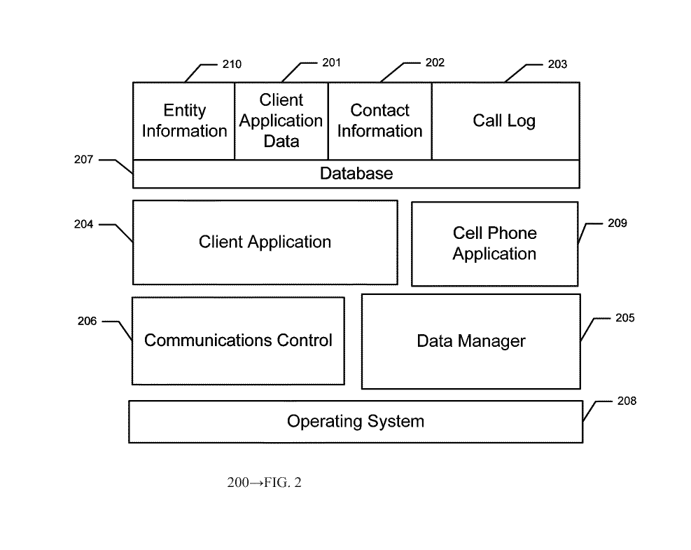

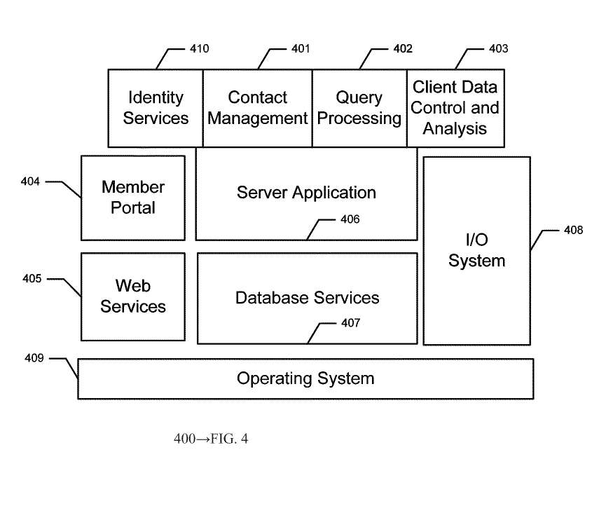

FIG. 1 is a block diagram illustrating an environment in which various example embodiments may be deployed. Elements 101 through 108 are smart phones and feature phones (collectively referred to as phones) which are connected through various wireless networks that are currently in place to support communications with the devices. In an example embodiment, the phone 101 connects, via the most accessible cell tower 106, to a central office 109, via a trunk line 107, using standard technology. Additionally, one or more Internet appliances 113 are connected through the Internet 112. Each phone 101-108 may have a software structure similar to a cell phone client architecture 200 described below. (See FIG. 2). As shown in FIG. 2, a phone may host a client application 204 that collects information about an entity using the phone, and transmits the information through links (e.g., through a cell phone radio transmission link 130, one or more trunk lines 107, and the Internet 112) to an application server (also referred to as an referral server) 110 connected to a database 111. The referral server 110 has a server architecture 400 described below. (See FIG. 4). As shown in FIG. 4, the referral server 110 includes a server application 406 that receives the information and adds it to the database 111. After the information is added to the database 111, it is processed by a server application (see 406 of FIG. 4) by executing the processes describe herein.

FIG. 2 is a block diagram depicting the cell phone client architecture 200, according to an example embodiment. The cell phone client architecture 200 includes entity information 210, client application data 201, contact information 202, a call log 203, a client application 204, a data manager 205, a communications control 206, a database 207, an operating system 208, and a cell phone application 209.

The operating system 208 provides base hardware control mechanism to applications, tasks, and services running on the phone 101. In example embodiments, the operating system 208 is provided by the manufacturer of the phone (e.g., 101, see FIG. 1) or, in other example embodiments, by a third party. The services communications control 206, the database 207, and the data manager 205 are built on the services of the operating system 208. The communications control 206 is an interface from the client application to the communications network. In the case of the cell phone based systems, the communications network may be the common carriers network, represented by trunk line 107 and central office 109, linked to the Internet 112. For the Internet appliances 113, the communications network may be the Internet 112. The communications control 206 interfaces with the client application 204 and acts as the port for the client application's 204 communications with the referral server 110. The data manager 205 controls the physical storage in the client and controls access, security, space management for various modules of the phone 101, such as the client application 204, the cell phone application 209, and the database 207. The client application 204 provides an interface to the various services provided by the referral server 110. The cell phone application 209 is provided by the cell phone vendor to provide cell phone services to a user. The database 207 stores, retrieves, and manages information in the various databases, including, for example, the entity information 210, the client application data 201, the contact information 202 and the call log 203, and provides the query and update services for these data. The entity information 210 includes information describing a user. The entity information 210 may be extended by the client application 204 to further include information useful to support the referral server 110 applications. The client application data 201 contains data structures that support the client application 204. The contact information 202 supports cell phone or web application contact list features. The contact information 202 is, in some example embodiments, augmented by the client application 204 to support the functions of the referral server 110 applications. The call log 203 is provided by the cell phone or web application. The call log 203 includes information about the user's contacts. The call log 203 may be accessed by the client application 204 to support the functions taught herein.

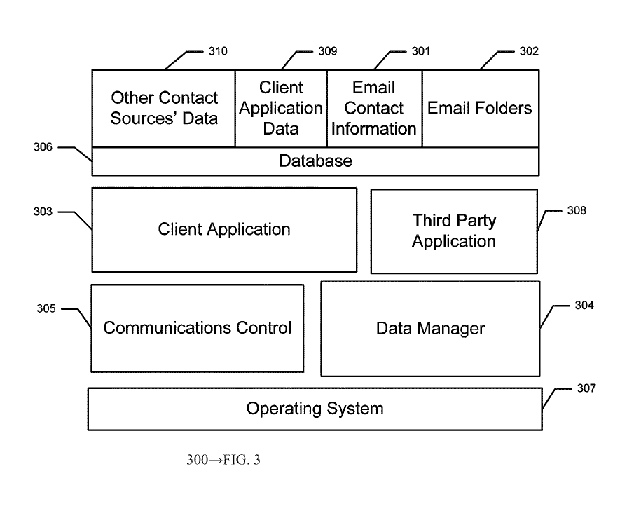

FIG. 3 is a block diagram depicting an Internet appliance client architecture 300, according to an example embodiment. The Internet appliance client architecture 300 includes other contact sources' data 310, client application data 309, email contact information 301, email folders 302, a database 306, a client application 303, a third party application 308, a communications control 305, a data manager 304, and an operating system 307.

The operating system 307 provides base hardware control mechanism to the modules of the Internet appliance client architecture 300. The operating system 307 may be provided by a manufacturer of the client system or a third party. The communications control 305, database 306, and data manager 304 are built on the services of the operating system 307.

The communications control 305 is an interface from the client application 303 to a communications network. As described earlier, in the case of the cell phone based systems, the communications network may be the common carriers network, represented by trunk line 107 and central office 109 (of FIG. 1), linked to the Internet 112. For the Internet appliances 113, the communications network is the Internet 112. The communications control 305 is interfaced with client application 303 and acts as a port for the client application's 303 communications with the referral server 110.

The data manager 304 controls the physical storage in the client by controlling access, security, and space management for the client application 303, third party applications 308 and database 306. The client application 303 provides an interface to the various services provided by the referral server 110. The third party applications 308 are provided by a number of sources (e.g., third party developers) and share the Internet appliance 113 with the client application 303. The database 306 manages the information in the various databases of other contact sources' data 310, client application data 309, email contact information 301 and the email folders 302, and provides various database services, such as query and update services for these data 310, 309, 301, and 302. Other contact sources' data 310 includes information about the user contact such as photograph, likes, dislikes, activities participated in, and other user information. The client application data 309 includes the new data structures to support the client application 303.

Email contact information 301 is used by email programs for the entity's contacts. It is augmented by the client application 303 to support the applications hosted on the referral server 110. Email folders 302 contain the email that has been received and sent by the user. The email folders 302 are the analog of the call log 203 of cell phone client architecture 200. (See FIG. 2). The email folders 302 are accessed by the client application 303 to support the functions taught herein.

FIG. 4 is a block diagram depicting a server architecture 400 for the referral server 110, according to an example embodiment. The server architecture 400 includes a conventional operating system 409 like IBM'S Z/OS, LINUX, UNIX, MICROSOFT WINDOWS 7 and other operating systems. From an architectural standpoint, an input/output (I/O) system 408 operates on top of the operating system 409 to provide services to manage I/O devices (e.g., disk storage and communications hardware). The other components of the system may interface with the I/O system 408 to perform these services. Database services 407 provide a repository for data structures of the server application 406. These data structures may be stored in a variety of forms, such as flat files, relational, hierarchical, and object databases. The web services 405 provide the protocols and controls to connect to the Internet 112. The web services 405 are used by the server application 406 to communicate with the various client machines. The member portal 404 receives requests for referrals from the clients from the web service 405 and passes them to the server application 406, which executes the various processes described herein. The server application 406 can be further subdivided into sub-functions including, in an example embodiment: identity services 410 (e.g., registration, login, and verification), contact management 401 (e.g., discovery, validation, and association analysis), query processing 402, and client data control and analysis 403. The structure and arrangement of the components of server architecture 400 is one of a number of implementations that one skilled in the state-of-the-art could design.

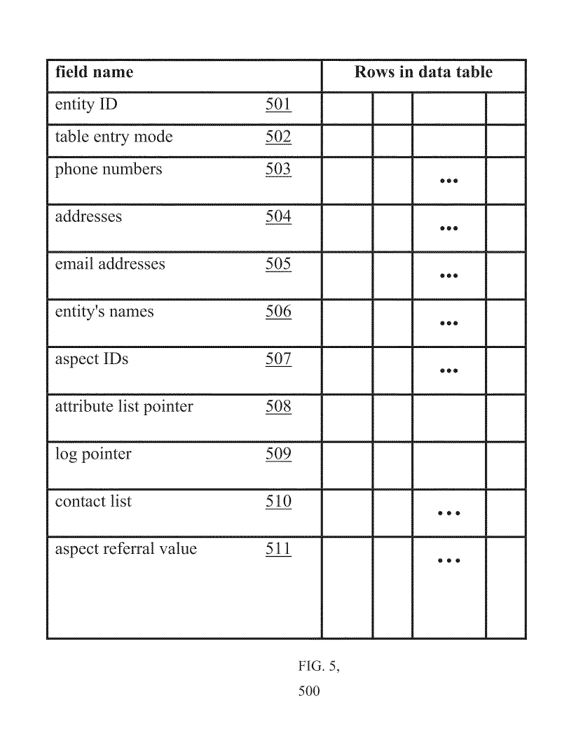

FIG. 5 is table showing content of an entity table 500, according to an example embodiment. An entity table describes an entity or an aspect (of an entity) of either a member or a contact of the member. The entities can be people, companies, businesses, organizations, etc. The entries of the entity table 500 are stored in a database and can be accessed by one or more of the fields. The fields in the entity table 500 shown in FIG. 5 are exemplary.

Entity ID 501 is the unique ID for an entity table entry. Table entry mode 502 indicates if this is the root entry for the entity, and contains one entity ID 501 that identifies the entity. The entity table 500 further includes:
one or more phone numbers 503 associated with that entity; one or more addresses 504, postal or street, associated with that entity;
one or more email addresses 505 associated with that entity; one or more entity's names 506 that entity uses;
aspect IDs 507, which list the ways in which the entity has elected to be known;
attribute list pointer 508, which specifies a list of attribute names which apply to this entity;
a log pointer 509, which is used to locate log entries;
a contact list 510 containing a list of entity IDs for all the contacts of the entity; and
an aspect referral value 511 which contains the referral value for the corresponding aspect ID 507.

Aspects such as “carpenter”, “machinist”, etc. indicate skills with entities and their attributes describe the services that they offer. For a carpenter, the services include: “furniture”, “framing”, and “restoration” among others. Aspects such as “retailer’, “service station owner”, etc, have attributes indicating the kinds of products they offer. For a retailer the products are quite diverse. For example, a retailer may be in the furniture business, in which case the attributes for the retailer might include: “furniture”, “recliners”, “bedroom sets”, etc. The structure of the aspect allows the rich description of the skills, products, and services that one might need a referral to. The fields in this structure were picked as representative and should not be construed to limit what is taught herein.

FIG. 6 is a table showing content of a contact list table 600, according to an example embodiment. As shown, the contact list table 600 includes:
a contact's entity ID 601, which is the unique identifier of the entity stored in the entity table 500 (see FIG. 5), and has a entity ID 501 that corresponds (e.g., is identical) to a contact's entity ID 601;
a contact type 602 indicates whether the corresponding contact is a direct or implied contact; and
a relationship strength 603, a value that indicates how strong a relationship exists between an entity and the contact.

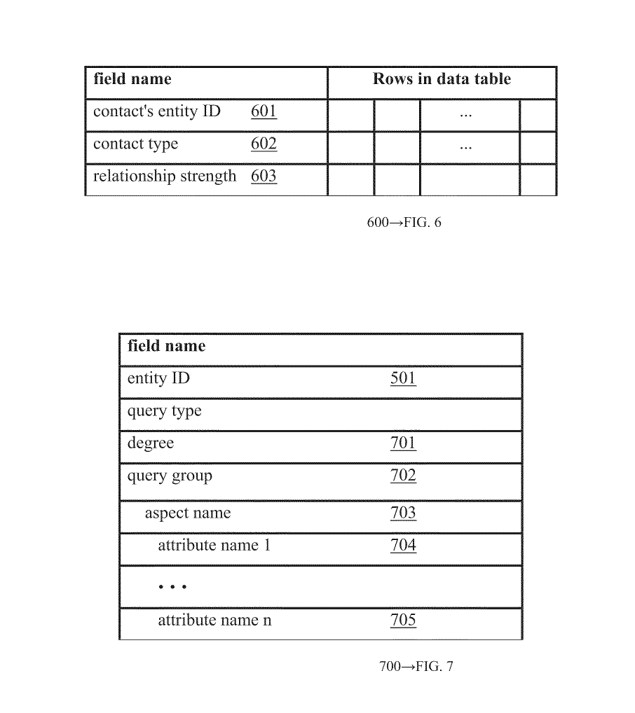

FIG. 7 is a table showing a referral query 700, according to an example embodiment. A referral query, in some example embodiments, may contain:
entity ID 501 indicating the entity requesting the query 700;
degree 701 which specifies the number of contact links allowed between the requester of a referral and the reference selected by the query 700; and
one or more query groups 702 with each having one aspect name 703 and the aspect name being modified by zero or more attribute names 704 through attribute name n 705, if appropriate.

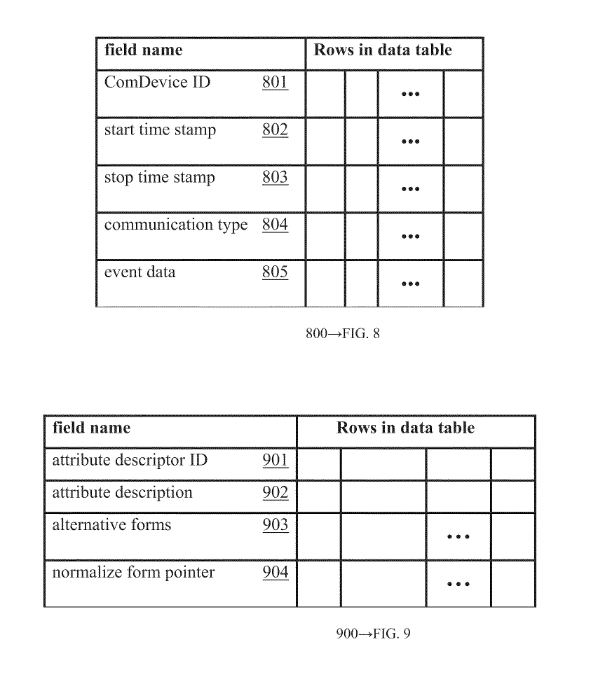

FIG. 8 is a table showing content of a communications log 800, according to an example embodiment. The communications log 800 describes the phone calls and other communications made and received by an entity ID 500 from any of the communications devices for the entity. The fields contained in the communications log 800 may include, for example:
comDevice ID 801 is a unique ID assigned to the phone or Internet appliance;
start timestamp 802 contains the date and time the communication started;
stop timestamp 803 contains the date and time the communication stopped;
communication type 804 indicates the type of call, e.g., call out, call in, call missed, voicemail received, text, email, Facebook posting, etc; and
event data 805 contains any text, image, or other digital information associated with the communication.

The communications log 800 is used to identify communications between an entity requesting a referral and the one or more entities or companies that were referred.

FIG. 9 is a table showing attribute descriptor data 900, according to an example embodiment. The attribute descriptor data 900 may, in some example embodiments, be composed of an attribute descriptor indicator, which is a fixed value that identifies the data structure as an attribute descriptor. The attribute descriptor data 900 also includes:
attribute descriptor ID 901, which is a normalized description of the attributes in the field attribute description 902;
a list of alternative forms 903 of the attribute description 902. The alternative forms 903 is a list of attribute descriptor IDs 901 that are synonyms for the attribute (e.g., “Dr.” is an alternative to “MD” but not vice versa); and
a normalized form pointer 904 points to the attribute descriptor that has an appropriate attribute description.

An appropriate attribute description is used when adding attributes to the database. For example, when adding the attribute “Baseball Referee” to an entity's profile, the system would substitute “Baseball Umpire”.

This list is created and updated in the process of adding entities and contacts to the system, and while updating the various entities and contacts information. Attribute descriptors are maintained in a separate table in the database and can be queried by various query languages including SQL. The attribute descriptors are stored in a database table with one entry for each unique attribute. The fields in this structure were picked as representative and should not be construed to limit what is taught herein.

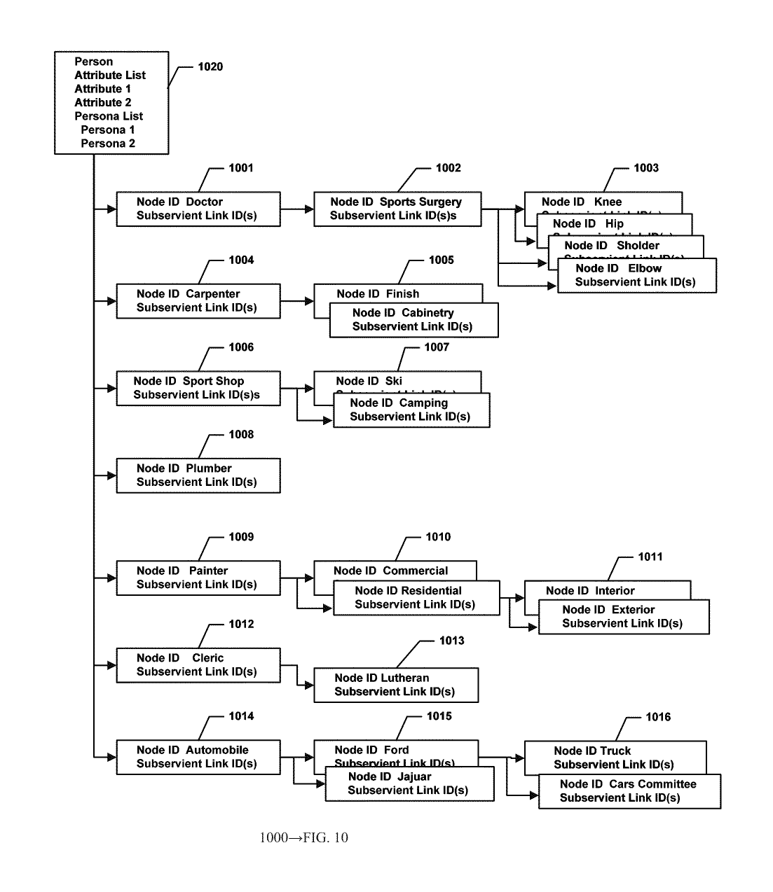

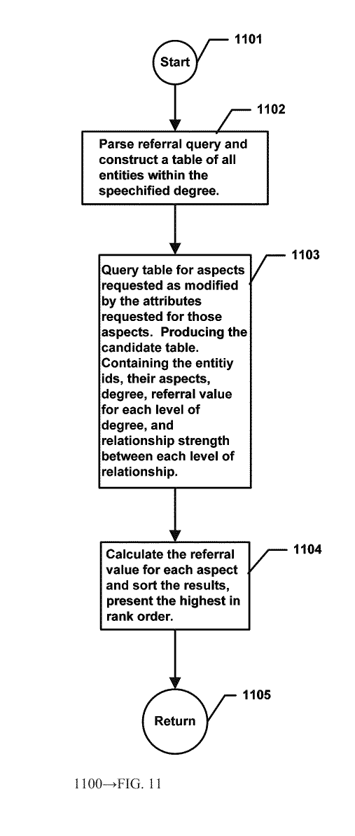

FIG. 10 is a diagrammatic representation of a representative attribute graph 1000, according to an example embodiment. The attribute graph 1000 describes how the attribute list pointer 508 (block 1001) and the attribute descriptor (see FIG. 9) compose a graph structure that represents the person specified in a person table entry (see FIG. 5). Each person table entry describes an entity that is a member of the system or is a contact of a member. Node 1020 is a person table entry and is the root node of the attribute graph 1000. Node 1020 contains the attribute list pointer 508 to a list pointing to the next level of the graph 1000 containing the primary attributes of the individual or persona. These nodes may be described in a node control block (e.g., 1001 to 1016). Nodes 1001, 1004, 1006, 1008, 1009, 1012 and 1014 are the highest level attributes or personas for the individual. Each of them can be linked to other attributes through additional node control blocks. In the case of node 1008, there are no subservient nodes. Nodes 1002, 1005, 1007, 1010, 1013, and 1015 are second level attributes or personas and are further linked to third level attributes represented by nodes 1003, 1011, and 1016. As many levels as appropriate may be used to represent an individual. This attribute graph 1000 may not be a separate entity, in some example embodiments, but may exist as a result of the IDs and pointers in the various data structures.

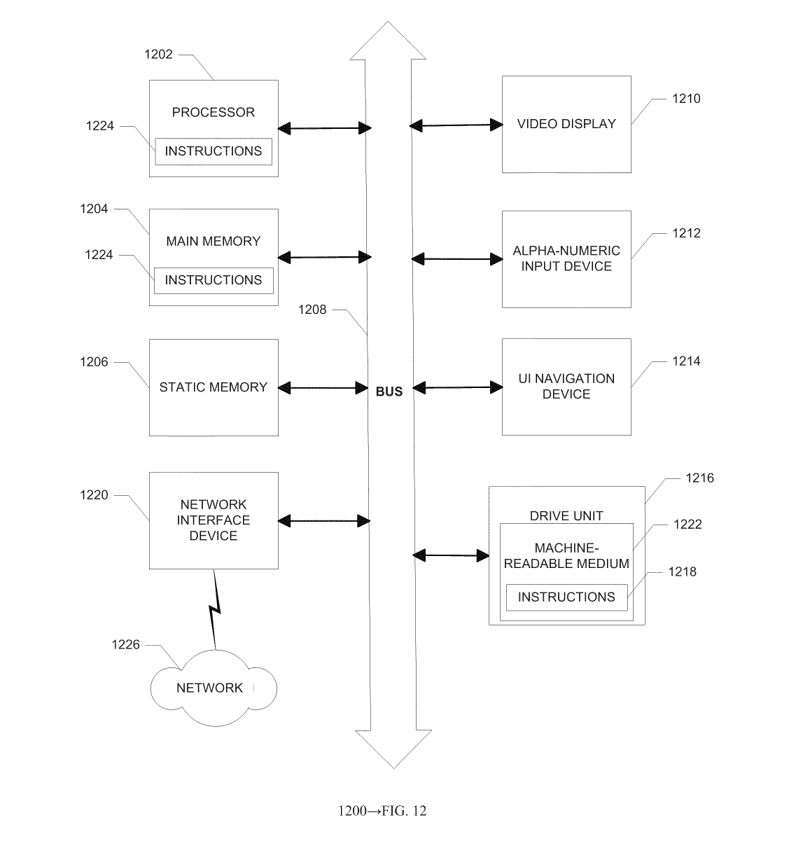

FIG. 11 is a flow diagram of the referral selection process 1100, according to an example embodiment. The flow diagram describes how the aspect referral value 511 (see FIG. 5) is developed. Operation 1101 gets control when the referral query 700 (see FIG. 7) is received and then passes control to operation 1102, which parses the query 700 and using entity ID 501 accesses the entity table for that entity. It then traverses the tree formed by the contact list 510 to the depth specified in degree 701. The process backtracks each time a leaf of the degree 701 criteria is met after recording the contents of the leaf's entity table 500 and the associated attribute graph 1000. Additionally each entity table 500 traversed and its associated attribute graph 1000 is recorded. Then control passes to operation 1103, which queries the recorded aspects to find those that meet the criteria specified in each query group's 702 aspect name 703 and attribute name 704 through 705, producing a candidate table containing the entity IDs, their aspects, degree, referral value for each level of degree, and relationship strength between each level of relationship. Then control passes to operation 1104, which calculates the referral value for the aspects each entity represented in the candidate table. The calculation of a referral value (RV) is of the form:

RV=c1f1(degree)□c2f2(strength)□c3f3(aspect referral value),

Where c1, c2, and c3 are fitting constants derived by data mining the history contained in database 111, and f1, f2, and f3 are functions derived from the database 111 by data mining. The value RV, entity ID 501, and aspect ID 507 are recorded in a temporary table and then sorted into descending order by RV; then the topped ranked entities are presented to the entity ID 501 specified in the referral query 700. The process operations in this diagram were picked as representative and should not be construed to limit what is taught herein.

Example embodiments may utilize a variety of metrics to indicate the value of potential referrals to a first entity. For example, as described above, the referral value may include a calculation based on degree, strength or aspect referral value, or some combination thereof. Other example embodiments may utilize the call logs to determine a metric based on experience. That is, an entity that communicates often with another entity may have a stronger relationship, for example. Other example embodiments may include actions that are stored in the database that are used to update the second entity's referral value, responsive to a request.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures should be given consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 12 is a block diagram of machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be an entity computer (PC), a tablet PC, a set-top box (STB), a entity Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device (e.g., a speaker) and a network interface device 1220.

### Machine-Readable Medium

The disk drive unit 1216 includes a machine-readable medium 1222 on which is stored one or more sets of data structures and instructions 1218 (e.g., software) embodying or utilized by any one or more of the methodologies or functions described herein. The instructions 1218 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more data structures and instructions 1218. The term “machine-readable medium” shall also be taken to include any tangible medium that is capable of storing, encoding or carrying instructions for execution by the machine and that cause the machine to perform any one or more of the methodologies of the present embodiments of the invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Transmission Medium

The instructions 1218 may further be transmitted or received over a communications network 1226 using a transmission medium. The instructions 1218 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
a database containing information concerning uniquely identified entities, the database further containing a list of attributes specifying products, services or skills provided by the respective entities; and
a server configured to:
compare a skill, service, or product requested by a first entity to a list of attributes for one or more second entities stored in the database, and
select potential referrals from the one or more second entities,
wherein the server is to provide one or more metrics indicating a value of the potential referrals to the first entity.

2. The system of claim 1, wherein the server is further configured to select a second entity based on a degree of relationship to the one or more second entities, and to use the degree of relationship in a calculation of the value of the referral.

3. The system of claim 1, wherein the server is further configured to select a second entity based on a strength of relationship to the one or more second entities, and to use the strength of relationship in a calculation of the value of the referral.

4. The system of claim 1, wherein the server is further configured to update a second entity's value of referral based on a communication log corresponding to the first entity and a communication log associated with the one or more second entities.

5. A system comprising:
a database containing information concerning uniquely identified entities, the database further containing a list products, services or skills describing the entities and a list of identifiers describing the entities; and
a server to compare the list of products, services or skills in a reference request from a first entity to another list of products, services or skills of identifiers for one or more second entities,
wherein the server is configured to:
provide one or more metrics indicating a value of a referral of the one or more second entities, and
present the one or more second entities as a reference to the first entity.

6. The system of claim 5, wherein the server is to select a second entity based on a degree of relationship between the first entity and the one or more second entities that are stored in database entries associated to the first entity, and to use the degree of relationship in calculating the value of a referral.

7. The system of claim 5, wherein the database includes strength of relationship between the first and the one or more second entities, and wherein the server is further configured to use a strength of relationship in calculating the value of a referral.

8. The system of claim 7, wherein the server is further configured to select the one or more second entities based on the strength of relationship, and to use the strength of relationship in calculating the value of the referral.

9. The system of claim 5, wherein the server is further configured to update a value of a referral of at least one of the one or more second entities based on a communication log of the first entity.

10. A method comprising:
storing skill, service, and product information concerning uniquely identified entities in a database, the database containing a list of attributes describing the entities;
comparing the list of skill, service, or product of a second entity to another list of one or more skills, services, or products for which the second entity has requested a referral; and
generating one or more metrics indicating a referral value of the second entity to a first entity.

11. The method of claim 10, including selecting the second entity based on a degree of relationship of a plurality of second entity candidates, and to use the degree of relationship to each of the plurality of second entity candidates in calculating the referral value of the second entity.

12. The method of claim 10 including selecting the second entity based on associations between the first entity and the second entity that are stored in database entries associated to the first entity, strength of relationship to the second entity, and to use the strength of relationship in indicating the referral value.

13. The method of claim 10 wherein the database contains one or more communication logs between the first entity and the second entity, and the one or more communication logs are used in the indicating of the referral value.

14. A method comprising:
storing products, services or skills belonging to uniquely identified entities in a database;
comparing a list of products, services or skills supplied by a first entity, the first entity requesting a referral to one or more lists of products, services or skills for one or more second entities;
based on the request, providing one or more metrics indicating a degree of match of the first entity to the products, services or skills associated with the one or more second entities; and
providing the list in whole or part to the first entity.

15. The method of claim 14, wherein the database includes information as to a degree of relationship between the first entity and the one or more second entities, and to use the degree of relationship in the indicating of the degree of match.

16. The method of claim 14, wherein the database includes information as to a strength of relationship between the first entity and the one or more second entities, and to use the strength of relationship in the indicating of the degree of match.

17. The method of claim 16, wherein the database includes data concerning the first entity action on a referral request and to update a second entity referral value based on the data.
